(19) United States
(12) Patent Application Publication
(10) Pub. No.: US 2003/0079120 A1
(43) Pub. Date: Apr. 24, 2003

(54) Web environment access control

(76) Inventors: Tina Hearn, Worcester (GB); David B. Hearn, Malvern (GB); Timothy J. Wilkinson, Malvern (GB)

Correspondence Address: NIXON & VANDERHYE, PC, 1100 N GLEBE ROAD, 8TH FLOOR, ARLINGTON, VA, 22201-4714, US

(21) Appl. No.: 10/231,444

(22) Filed: Aug. 30, 2002

Related U.S. Application Data
(63) Continuation of application No. 09/980,843.
Application No. 09/980,843 is a 371 of international application No. PCT/GB00/02049, filed on Jun. 6, 2000.

(30) Foreign Application Priority Data
Jun. 8, 1999 (GB) 9913165.8

(51) Int. Cl. H04L 9/00; G06F 15/16

(52) U.S. Cl. 713/150; 709/229; 380/277

(57) ABSTRACT

An access control system and method in a web environment having pre-encrypted files on a web server decryption keys provided to authorised users and a trusted user proxy for controlling file access and decrypting files received, in which files are encrypted using a file key (FK), and the FK is encrypted using a Group Encryption Key (GEK), and the user proxy has a Group Decryption Key (GDK) to decrypt the FK and the file. Each encrypted file is labelled with an Access Control Expression (ACE) which indicates which users or groups of users are authorised to decrypt and observe the file; this provides a secure client server system having pre-encrypted documents on the web-server, released to a decryption proxy on the client side, which controls access to, and decrypts the documents the client is allowed to see.

This invention relates to a method and system of providing accreditable access control in a web environment, in particular to methods using encryption and a user proxy

The business benefit of an Intranet web is that information is available to those that need it in a timely fashion. However, most large organisations have some information that is considered sensitive and is not needed by all users. For example, Human Resources data might need sharing amongst members of the HR department, while other people are prevented from accessing it.

Existing solutions to this problem, for example “Role Based Access Control for the World Wide Web”, J. Barkley et al, Procs. 20^{th} National Information Systems Security Conference, Baltimore, October 1997., rely on complex web server software working correctly and being configured correctly, which means there is considerable risk that the controls will fail. In many commercial organisations, as long as the information remains on the company Intranet, the risks involved will be worth taking, given the relatively limited damage that would be caused if the controls fail. However, an organisation which handles particularly sensitive data, such as health care records or security or financial information, may find the risk unacceptable.

With increased use being made of electronic commerce to make trading more efficient, the boundaries of an Intranet are fast being eroded. Increasingly, an organisation will host some proprietary information belonging to its trading partners on its Intranet and these partners may need some access to the Intranet in order to conduct business. Typically, the partners will be in competition with each other and the host organisation would need to ensure that the information belonging to one partner is not revealed to another (either accidentally or deliberately). Should an access control failure occur, damage to the host organisation's reputation might lead to lost business and even claims for damages. In these circumstances, a commercial organisation may find the risk of complex access control software failing hard to justify to the shareholders or potential customers.

One way of controlling access to information in a web without relying on the web server software is to use separate servers for information of different sensitivities. Unfortunately this solution does not scale when many combinations of information sensitivity and user trustworthiness are required.

The only way a single untrusted web server can be used to handle information of different sensitivities is to remove responsibility for access control and separation from the server software. This can be achieved by encrypting documents, in a key not available to the server, before they are given to the server. This removes access control responsibilities from complex web server software and becomes a matter of distributing data decryption keys appropriately. Unfortunately, the general problem of key distribution is by no means a simple task, but some options are disclosed herein.

Web server and browser software is complex and its security features are prone to failure or misconfiguration, and hence cannot be trusted to handle sensitive information appropriately. The present invention avoids this problem by ensuring that the web server only handles encrypted data and that release of data from the browser is carefully controlled.

According to the present invention a system is provided that uses an encryption based approach to provide trustworthy access control in a web based on untrustworthy web servers comprising a system of secure communication over a distributed network using pre-encrypted files on a web server and providing a decryption key to authorised users whereby decryption and access control takes places on a trusted user proxy.

This provides a secure client server system having pre-encrypted documents on the web-server, released to a decryption proxy on the client side, which controls access to, and decrypts the documents client is allowed to see.

Also provided is a method of controlling documents within a web environment comprising by restricting access to files to a limited number of groups of users across a computer network by means of encrypting the files by means of a File Key (FK), encrypting the FK by means of a Group Encryption Key, and providing only the limited number of groups with a means of decrypting the FK.

More specifically provided is a method of communicating secure information in a distributed system having a server side including a web server and a server browser, and a client side including a browser and a user proxy including;

labelling each file with an Access Control Expression (ACE), which indicates which

users are permitted to observe the file;

a file encryption key (FK) is generated and used to encrypt the file; the encrypted file is provided with a header containing information including the ACE

enabling authorised users to decrypt the encrypted file;

a group encryption key (GEK) is generated for defined groups of authorised users;

a GEK encrypts the FK and adds it to the file header;

placing on the web server the encrypted file, unencrypted information relating to the file, a header file containing Group ID, the FK in GEK, and the ACE;

delivering to the users proxy a group decryption key (GDK)

user retrieves file and proxy examines incoming encrypted file ACE in the header to see how or if decryption can take place;

users group decryption key (GDK) is used to decrypt the file key (FK) from the header;

the file is then decrypted using the file key FK,

the decrypted document is delivered to client side web browser.

Using encryption to protect information does not solve all the problems, because it is necessary to defend the cryptographic elements from misuse by the untrustworthy servers and applications. The basic protection mechanisms needed in the workstations and servers are found in Windows NT and Unix, but initial key distribution remains a difficult problem to solve in general. Key distribution in a closed NT environment is relatively straightforward.

The present solution does not remove the need for trusted software, but it reduces the scale considerably. Rather than trusting web servers and browsers, including all their plug-ins, only the encryption and decryption proxies and the release server need to be trusted. These are quite easy to trust as they are small and simple.

Preferably the application software used by authors to create web content must be prevented from modifying group encryption keys. This is because the application, which must be considered untrustworthy, could gain access to all data subsequently released by replacing the group encryption key with one for which it knows the corresponding group decryption key.

Preferably the system uses asymmetric keys. The advantage of asymmetric cryptography is that it gives extra protection in the event that proxies are compromised

Alternatively, having protected both the encrypting and decrypting keys from disclosure and modification, it would be possible to use symmetric cryptography for the group keys.

An embodiment of the invention will now be disclosed with reference to the accompanying drawings

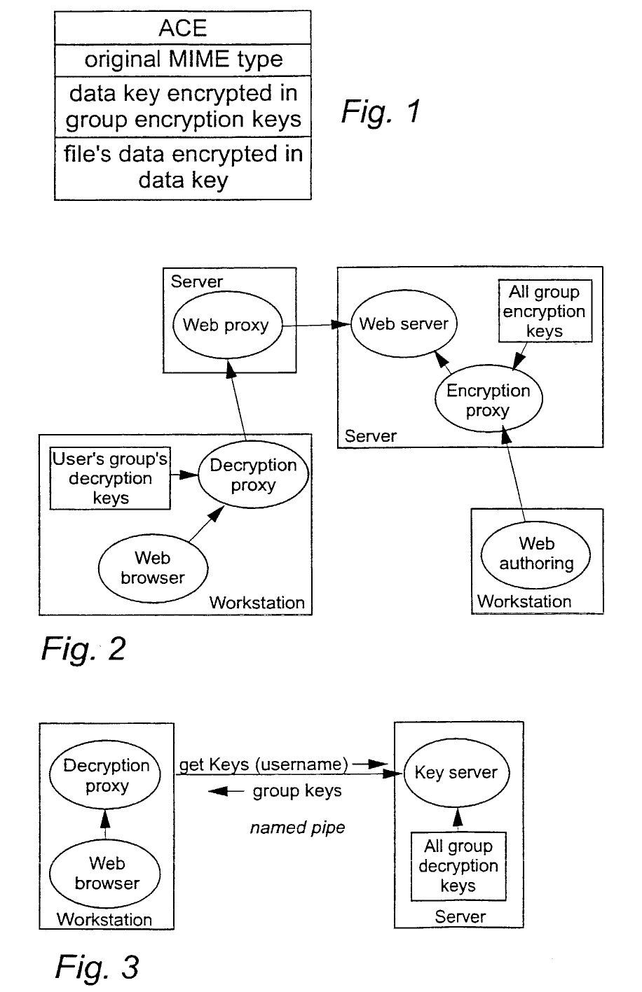

FIG. 1 Format of protected files

FIG. 2 Overall Architecture

FIG. 3 key distribution

The access control scheme can be described in terms of groups, each containing a number of users. These groups will usually represent a particular business function, project or trading partner. Each file accessed through the web server is labelled with an Access Control Expression (ACE), which indicates those users who are permitted to observe the file.

An ACE is a formula defined in terms of groups combined with operators “&” and “|”, which are ‘and’ and ‘or’ respectively. Files with an ACE of the form “X & Y” can be observed by any user who is in group X and group Y, while files while ACEs of the form “X|Y” can be observed by any user who is either in group X or group Y.

Complex ACE formulae can be used, and some examples are shown below:

| ACE | permitted groups |
|---|---|
| X & Y & Z | X Y Z |
| X & (Y \| Z) | X Y or X Z |
| (W \| X) & (Y \| Z) | W Y or W Z or X Y or X Z |

Suppose an organisation had a number of departments that handle sensitive information, including Engineering (ENG) and Finance (FIN). In addition, the organisation handles sensitive information belonging to its customers, who include ACME and DERA. A group would be created for each department and for each customer, and staff would be placed in these groups according to the departments for which they work and the customers that they serve.

Now sensitive engineering data about work for ACME would be labelled “ENG & ACME”. An engineer that was not working on the ACME project would not be in the ACME group and so would be unable to see this data. Similarly, sensitive financial data about work for ACME would be labelled “FIN & ACME”.

However, if the organisation were working on a joint project for ACME and DERA, the engineering details might be labelled “ENG & (ACME|DERA)”, in which case any engineer working on an ACME (or DERA) project will be able to see details of the joint project as well. Alternatively, the data might be labelled “ENG & ACME & DERA ”, in which case only engineer who work on both ACME and DERA projects would be able to see the data.

The ACE applied to a file accessed through the web server is not in itself used to mediate access. Instead, when the file is released into the server its ACE is used to determine the way the file's data is encrypted. The scheme uses a mixture of symmetric and asymmetric cryptography as follows.

When a file is released, a new symmetric key is generated and this is used to encrypt the file. This key is called the file's data key. The resulting encrypted data is prepended with a header before being released to the web server. The header contains the information that allows legitimate recipients to decrypt the encrypted data.

An asymmetric key pair is generated for each group in the access control scheme. This key pair is used to distribute a file's data key to those who are permitted to observe the file. One key of the pair is a key encrypting key and the other is a key decrypting key.

The encrypting key is used to release information to the group, and the decrypting key is used by members of the group to observe data released to them.

In the simple case where the ACE is just a single group, the file's data key is encrypted using the group's encryption key. The result is placed in the header along with the file's label, as shown in FIG. 1. The way in which the data key is encrypted in general is explained below.

A file's header contains the file's ACE, the file's data key encrypted in a way determined by the file's ACE, and the file's data. The function for encrypting the data key of a file D whose ACE is A is denoted H(D,A), and is defined as follows:

H(D, G)=e_{G}(D)

H(D, x|y)=H(D,x)ˆ H(D,y) //ˆ is the concatenate operator

H(D, G & x)=e_{G}(H(D,x))

H(D, (x|y) & z)=H(D, (x & z)|(y & z))

where

D is the file data key

G is a simple ACE of one group

x, y and z are arbitrary ACEs

e_{G}(□) is the result of encrypting □ in the encrypting key associated with group G

To observe a file, it must be decrypted using its data key. This can be recovered from the file's header if certain group decrypting keys are known. The ACE determines which combinations of group decrypting keys permit the data key to be recovered.

The function that is used to recover a data key from the encrypted data E and ACE A in the header is denoted R(E,A). This either retrieves the decryption key or returns an error. It is defined as follows:

R(E, G)=If user in G then d_{G}(E) else fail

R(Exˆ Ey, x|y)=either R(Ex, x) or R(Ey, y) or fail if both fail

R(E, G & x)=R(d_{G}(E),x)

where

E, Ex and Ey are encrypted key data from the header

G is a simple ACE of one group

x and y are arbitrary ACEs

d_{G}(□) is the result of decrypting □ in the decrypting key associated with group G

To observe a file, the ACE in the header is examined to determine how the encrypted data key should be recovered. In the simple case, where the label is just a single group, the group's decryption key is used to recover the file's data key from the header. Once the data key is obtained, the file's data can be decrypted. If the group's decryption key is not available, because the user is not a member of the group that is permitted to observe the file's data, there is no way the file's data can be accessed.

When HTTP is used to retrieve a file from a web server, the reply includes information about the type of the file. This information is included in the HTTP Content—Type reply header field, whose format is a MIME type. Standard web servers use so-called ‘mailcap’ files to determine, on the basis of file extension, which MIME type is to be associated with each file they deliver. In this invention, all encrypted files are given an extension of “.bob” and a MIME type of “application/x-bob”is associated with this.

When such Bob format data is decrypted, in a manner that is described later, the type of the result is changed to the original type taken from the header. This means the browser knows how to handle the data in the normal way.

Most applications of public key cryptography assume that a user's application software can be trusted to protect keys from disclosure and to use them only in accordance with the user's wishes. Here, however, the assumption is that complex web server software cannot be trusted, and so the same level of distrust must be levelled at the workstation applications. Thus a group's decryption key must not be made available to a user's ordinary application software, as this could pass the key to other users who are not part of the group.

The solution is shown in FIG. 2. An HTTP decryption proxy is installed on the user's workstation and access controls provided by the workstation's operating system are set so that the proxy has access to a file containing the user's group decryption keys, but the user's application software is denied any access to this file. The access controls are also used to protect the proxy's binary image and configuration data from modification.

The job of the decryption proxy is to transparently decrypt any encrypted data retrieved from a web server and to restore the original MIME type of the data. The proxy is trusted to keep the group decryption and document keys private, regardless of what data it handles (for example, it defends against buffer overrun problems).

The user's web-enabled applications, including their browser, would be configured with the local decryption proxy as their web proxy, while the decryption proxy would be configured to chain-on to the network's real web proxy if one is required.

A group's decryption key is protected so that an application cannot pass it on to users who are not in the group, as this would give the recipient access to all files released to the group. Similarly, a file's data key is protected, otherwise this would give the recipient access to the particular file. However, once a file has been decrypted and given to an application, the cryptography does not stop the application passing the decrypted data to another user. This is part of the general problem of controlling the release of data while using untrustworthy application software.

Protecting a file's data key from disclosure also affords extra protection to the group decryption key. A user in possession of a document key, and the same key encrypted with a group encryption key, has the potential to mount a brute force attack to obtain the group decryption key. With a single document key, the user has only a small amount of information on which to base their attack,.

Application software used by authors to create web content must be prevented from modifying group encryption keys. This is because the application, which must be considered untrustworthy, could gain access to all data subsequently released by replacing the group encryption key with one for which it knows the corresponding group decryption key.

Note that, having protected both the encrypting and decrypting keys from disclosure and modification, it would be possible to use symmetric cryptography for the group keys. The advantage of asymmetric cryptography, however, is that it gives extra protection in the event that proxies are compromised. For example, should a server's group encryption keys be divulged, no data is compromised if asymmetric cryptography is used.

Web content is typically created on a workstation and uploaded into the web server using FTP or HTTP. The process of releasing web content can be controlled by placing a proxy, for the appropriate protocol, between the web authoring application and the web server. This encryption proxy needs access to the all the group encryption keys, so it can encrypt a released file in accordance with its ACE. The encryption proxy is trusted to allow the group encryption keys to be modified only under strictly controlled circumstances. In addition, the proxy keeps the encryption keys private, though this is less important.

FIG. 2 shows the placement of the encryption proxy in the current implementation. As an alternative, the proxy could be placed on the user's workstation, which has the advantage of protecting the data's from eavesdropping as it passes from workstation to server. The disadvantage, however, is that the encryption keys need to be more widely distributed.

In order to know how the file's data should be encrypted, the encryption proxy needs to know the file's ACE. The way this is conveyed from the web authoring software running on the user's workstation to the proxy is disclosed later

An individual document key can be changed easily. It is simply a matter of recovering the original file data key, using the decrypting key of some group which can access it, decrypting the data, and replaying the normal process associated with publishing.

The decrypting group keys of the groups to which a user belongs, need to be distributed privately to the decryption proxy on the user's workstation. One way of achieving this is to make use of public key technology. Each proxy would be identifiable by a distinguished name and associated public key, most likely wrapped together into an identity certificate. The proxy would hold the complementary private key in private local storage. An administrator wishing to place a consumer group decryption key into a proxy would obtain the identity certificate corresponding to the proxy. After verifying the certificate, the public key contained within it can be used to encrypt a group key for forwarding to the proxy. Only a holder of the proxies' private key can unwrap the group key.

At this point the message containing the hidden group key can be presented to the user of the system by, for example, electronic messaging. Once the message has been inserted into the proxy, the proxy can unwrap the message to reveal the group key and place it in private storage. Additional fields could be associated with the key, such as a time after which the key is invalid.

The proxy's private key can be made available to the proxy initially. In organisations that prefer central key generation, the private key could be physically or electronically delivered to the proxy in a secure manner, and then imported through a trusted import function. Alternatively, the proxy could generate its own private key at installation time, and export the corresponding public key for signature by a certification authority.

While the ultimate solution is to distribute keys through a public key infrastructure, as discussed above, a lighter-weight alternative is possible using the security mechanisms of a networked operating system. These mechanisms only work in well-managed closed networks, so the technique will not always be applicable, but where the operating system's environmental assumptions hold it is perfectly adequate.

A key distribution scheme for this invention has been implemented using the security functionality provided by Windows NT. The relevant features are Services and Named Pipes.

A Named Pipe is a communications pipe mechanism whose use is subject to NT security in much the same way as files. A server process on one machine can create a named pipe and set its access control list so that only processes running under certain user accounts can connect to it. When a client process does connect to the pipe, the server process can establish the identity of the client account.

A Service is a process that is started when a machine boots and generally runs under a special system account, rather than one associated with a particular user. Ordinary users may subsequently log-in to the machine and the service continues to run.

FIG. 3 shows the general arrangement of processes and services used to distribute group keys. A simple database of group decryption keys is stored on a key server host. The decryption proxy on each workstation is installed as a service and this runs under a special system account. These proxies obtain the user's group keys from a process, the Key Server, using a Named Pipe. The Key Server could reside on the web server host, though it would be better to install it on a more tightly controlled machine.

The decryption proxy runs as soon as the workstation boots. Whenever it detects that a user has logged-on to the workstation, the proxy connects to the key server's Named Pipe and sends the account name of the user who has just logged on. The key server obtains a list of groups to which the user belongs and then returns a list of decryption keys for these groups to the decryption proxy.

Once the decryption proxy receives the list of group keys for the user, it can transparently decrypt any encrypted data returned from the web server. However, the proxy must ensure that any incoming connections are not from a remote workstation, in case a user in a different group is logged-on there.

The access control lists on the key server's Named Pipe are set so that only the service account used by the decryption proxies can access it. A user's application processes therefore cannot obtain any decryption keys from the web server.

On a well-managed web site, files are not changed in an ad-hoc way. Subsets of web pages and links are updated or otherwise modified, and then uploaded to the server in a publishing operation. It is within this publishing function that access control requirements can be stated and release can be sanctioned.

The first step in publishing is for an author to create one or more documents for publication. Each document needs to have an ACE associated it. The way this is done depends upon the application used and the environment in which it runs. A simple version might use Microsoft Word to create the documents, in which case the ACEs can be held as document properties. If the workstation provides support for labelled documents, the ACEs could be derived from the security labels of the documents. The present invention does this, using NT workstations augmented with Purple Penelope, a DERA system described in “Private Desktops and Shared Store”, B. Pomeroy and S. Wiseman, Procs. 14^{th} Annual Computer Security Applications Conference, Scottsdale, December 1998, to provide the labelled documents.

Once the documents have been assembled, they must be released to the web server. Since the assumption is that application software is not sufficiently trustworthy to protect documents from disclosure, the release process must be controlled. In The present invention, release is handled by a trustworthy service running on the user's NT workstation. Ordinary applications can request this service to release files to the web server. To defend against an application making inappropriate requests to release some data, the user is asked to confirm each request.

The release service obtains the user's sanction using a trusted path interface, to avoid the sanction being spoofed by an application. A trusted path interface is supported directly by Purple Penelope, which uses NT's standard access controls on Desktops to implement it. As part of the release sanction, the user is asked to confirm the ACE for the product to be released. This prevents the application from changing the ACE after the user has set it and before the file is released.

The release service may also check the content of the files to be released to ensure that no data is hidden from the casual reader. This is important as an application may attempt to leak data by hiding it in files that are to be released. While checking for hidden text, the service may also generate a summary of the file's content. This can be presented to the user when they are asked to confirm the release, so that an application that attempts to change the data being released may be discovered.

For example, suppose an author prepares a web “page” comprising some HTML text and two images in GIF format. The release service can check that the application has not hidden sensitive data in comment tags in the HTML, and if any is found the user can be warned not to release the data. In the trusted path dialogue, which asks the user to confirm the release request, the “page” would be summarised, so the user can see the number of paragraphs of text and the number of images being released. If this is unusual, the user has a chance of rejecting the confirmation request.

The release sanction can be obtained separately for each “page”, or a single sanction for all the “pages” to be released as one “product” can be obtained. Whilst the former is in principle more secure it could also be seen as an inconvenience. It is common for users to take more care over a single operation than one they need repeat many times. Hence better overall security might be obtained by adopting a more relaxed approach in which one update involving several “pages” is sanctioned as a whole.

Assuming the user confirms the intention to release the data, the release service proceeds to upload the files to the encryption proxy on the server. It is important to prevent applications directly uploading data to the server's encryption proxy, as this would provide them with a way of leaking data. This protection can be achieved by using cryptographic techniques, but in a closed NT based environment named pipes can be used.

Another issue is dynamic content, where web pages are generated on demand based on the data in a database. For example, when a user browses a dynamic page, a CGI script may access a database and create some HTML that is returned to the user.

With The present invention, the script passes the appropriate request to the database, but the sensitive results are returned as encrypted “bob” files. These are embedded indirectly into the generated web page by using HTML <OBJECT> tags. Each <OBJECT> tag is a link to an encrypted result, but the data referred to is displayed in place in the web page, rather than being shown as a hyperlink. Thus if the user's groups are such that they can access all the results, the page is completely filled in, while if they are not some fields will display an error message.

The present invention “bob” encryption process could be included in the database engine, by exploiting the Object Relational features of Oracle 8 or Informix IUS, see “Securing an Object Relational Database”, S. Lewis and S. Wiseman, Procs. 13^{th} Annual Computer Security Applications Conference, San Diego, December 1997.

or a separate trusted server process could be interposed between the scripts and the database. Alternatively, the sensitive data could be encrypted before it is placed in the database. This has the advantage that the database engine need not be trusted to handle the sensitive data properly, but the disadvantage is that the data cannot be searched or manipulated (e.g. projection) within the database.

Independently of when the data is encrypted, its release into the database must be sanctioned, as the producer is not involved when the data is served out to a requestor. Techniques for doing this using object-relational database engines are discussed in “Securing an Object Relational Database”, S. Lewis and S. Wiseman, Procs. 13^{th} Annual Computer Security Applications Conference, San Diego, December 1997.

Controlling the release of data into the server is not a trivial problem, because to be effective the controls must be closely integrated with web authoring application software. Such software is relatively immature, but progress in standardising distributed web authoring and versioning extensions to HTTP (http://www.ics.uci.edu/pub/ietf/webdav/) should simplify the design of the release service and make it more widely applicable.

Finally, the addition of access controls into a web conflicts with the natural intention of a web to be freely accessible. This creates considerable tension, as evinced by the problems associated with search engines. This aspect of the problem is worthy of more research.

The method of document release for the system or method disclosed above may comprise the following steps

creating a file

associating an ACE with the file

releasing the file to the web server

obtaining the users'sanction via a trusted path interface

asking user to confirm ACE

checking content for prohibited material

uploading the file to the encrypt proxy on the server

A computer readable medium having a program recorded thereon may be provided in which the program causes a computer running the program to execute a procedure for access control according to the method disclosed above

A computer program element adapted to cause a computer using such element to perform the method disclosed above may also be provided.

A software carrier carry access control software which when operational provides means of operating method disclosed above may also be provided.

1. An access control system in a web environment;
having pre-encrypted files on a web server;
decryption keys provided to authorised users;
and a trusted user proxy for controlling file access and decrypting files received.

2. A system as claimed in claim 1, in which documents are encrypted using a file key FK, and the FK is encrypted using a Group Encryption Key GEK, and the user proxy has a Group Decryption Key GDK to decrypt the FK and the file.

4. A system as per claim 1 or 2, in which the GDK is symmetric with the GEK;

5. A system as in any previous claim in which user proxy is a unit operating functionally separately to client side operating system.

6. A system as in any previous claim in which each encrypted file is labelled with an Access Control Expression (ACE) which indicates which users or groups of users are authorised to decrypt and observe the file;

7. A system as claimed in claim 6 in which the ACE is a formula defined in terms of groups combined with operators ‘and’ and ‘or’.

8. An access control system as claimed in claim 6 whereby the different groups can be combined formulaically so as to limit access to users in the right combination of groups.

9. An access control system as in any previous claim whereby each user within a group is provided with one or more group decryption keys stored securely in the user proxy.

10. An access control system as in any previous claim whereby the users can only decrypt files if the user has the right combination of GDKs for access.

11. A system as claimed as in any previous claim in which the GDKs are distributed to authorised users using public key technology;

12. A system as in any previous claim, in which the GDK is distributed using the security mechanisms of a net worked operating system;

13. A system as in any previous claim, in which the GDK becomes invalid after a defined period of time;

14. A system as in any previous claim in which the group decryption key is protected so that it is tamper proof and an application cannot pass it on to users not in the defined group;

15. A system as in any previous claim in which the file data key is protected so that it is tamper proof and an application cannot pass it on to other users;

16. A system as in any previous claim in which prior to encryption, files are checked by a release service for correct ACE and hidden data;

17. A system as in any previous claim in which where data is drawn from other sources such as backend database it is embedded in a template rather than shown as a link;

18. A system as in any previous claim in which data drawn from other sources is encrypted by the database engine;

19. A system as in any previous claim in which data drawn from other sources is encrypted by a separate trusted server between database and web documents;

20. A system as in any previous claim in which files are controlled by the ACE at variable granularity page by page.

21. A system as claimed in claims 1-20 in which the system has encryption proxy located on user workstation

22. A system as claimed in claims 1-20 in which the system has encryption proxy located on web server

23. A decryption proxy for a system as in any previous claim which is installed on user workstation with access controls provided by workstation operating system set that the proxy has access to a file containing users group decryption key so that users application software is denied access to this file

24. A method of access control in a web environment, including;
pre-encrypting files on a web server and providing a decryption key to authorised users;
controlling access and effecting decryption by means of a trusted user proxy

25. A method of restricting access to files to a limited number of groups of users across a computer network by means of encrypting the files by means of a File Key (FK), encrypting the FK by means of a Group Encryption Key, and providing only the limited number of groups with a means of decrypting the FK.

26. A method of controlling access to secure information in a distributed system having a server side including a web server and a server browser, and a client side including a browser and a user proxy including;
labelling each file with an Access Control Expression (ACE), which indicates which users are permitted to observe the file;
a file encryption key (FK) is generated and used to encrypt the file;
the encrypted file is provided with a header containing information including the ACE enabling authorised users to decrypt the encrypted file;
a group encryption key (GEK) is generated for defined groups of authorised users; a GEK encrypts the FK and adds it to the file header;
placing on the web server the encrypted file, unencrypted information relating to the file, a header file containing Group ID, the FK in GEK, and the ACE;
delivering to the users proxy a group decryption key (GDK)
user retrieves file and proxy examines incoming encrypted file ACE in the header to see how or if decryption can take place;
users group decryption key (GDK) is used to decrypt the files data key (FK) from the header;
the file is then decrypted using the File key FK,
the decrypted file is delivered to client side web browser

27. A method as per claim 26, in which the GDK is symmetric with the GEK;

28. A method as previously claimed in which the access controls are set on user operating system so that proxy but not application software has access to the file containing group keys (GK);

29. Method of file release for the system or method as in any previous claim comprising the following steps
creating a file
associating an ACE with the file
releasing the file to the web server
obtaining the users'sanction via a trusted path interface
asking user to confirm ACE
checking content for prohibited material
uploading the file to the encrypt proxy on the server

30. A computer readable medium having a program recorded thereon in which the program causes a computer running the program to execute a procedure for access control according to the method of any of claims 24-29

31. A computer program element adapted to cause a computer using such element to perform the method of any of claims 24-29

32. A software carrier carry access control software which when operational provides means of operating method according to any of claims 24-29.

33. A system and method of controlling access to web environments substantially as herein described.
